(19) United States
(12) Patent Application Publication
(10) Pub. No.: US 2006/0088192 A1
(43) Pub. Date: Apr. 27, 2006

(54) Identification system

(76) Inventors: Stefan Parhofer, Munchen (DE); Herbert Meyerle, Maisach (DE); Bernd Dietel, Weissenstadt (DE)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/546,621

(22) PCT Filed: Sep. 8, 2004
(86) PCT No.: PCT/EP04/10030

§ 371 Date: Aug. 23, 2005

(30) Foreign Application Priority Data
Sep. 8, 2003 (DE) 103413707

(51) Int. Cl. G06K 9/00

(52) U.S. Cl. 382/115

(57) ABSTRACT

A system and a method for the secure identifying of persons and for permitting or denying of a logical and/or physical access to a target means is provided. The system comprises a portable ident medium having at least one biometric sensor, at least one input element and at least one output element, a processor having a memory and a software as well as a transmitting and receiving electronic and a counter station which is located at a target means or is cooperating with said target means, having a reading and evaluating electronic for checking the authorization of the ident medium, an actor and a memory, wherein an alternating magnetic field is generated for the encoded, bidirectional date exchange or for performing a challenge response, signals are transmitted in the low frequency range and wherein the ident medium and/or the counter station are programmable.

The present invention relates to a system and a method for the secure identifying of persons and for permitting or denying logical and/or physical access to a target means. Especially, the system and method according to the present invention serves for permitting or denying logical and/or physical access to target means like locking means, door cylinders, furniture, switchboards, automobiles, vaults, safes, cash dispensers, driving or operating permits, PC log-ons and/or the releasing of firearms.

Systems for identifying persons are known from the state of the art. Thus, DE 199 29 894 A1 discloses an apparatus and a method for the dactyloscopic identification of persons in form of an electronic key comprising a sensor for detecting finger prints, a means for the entire processing of the sensor image as well as a means for storing the features of a finger print. Here, the processing consists of two parts, the finger print recognition on the one hand and a cryptologically secured interface to the environment made by known technology in form of a cryptographic protocol.

DE 198 48 001 A1 describes a method for releasing an automobile for operation, in which due to inserting a data carrier into a reading means in the automobile, user specific information of the owner, which are detected by the reading means, are stored on said data carrier are fed to a calculation unit in the automobile and are compared with information stored therein, wherein further personal information are requested from the user by a recognition means, are fed to the calculation means and are compared with information related to the person of the user, which are stored in the automobile, and the automobile will or will not be released for operation on the basis of the result of the comparison of the personal information.

DE 101 26 050 A1 suggests a method for detecting users of an automobile, in which a physiological feature of the user is detected and is compared with stored data, whereby it should be ensured that the automobile is actually used by an authorized user.

DE 197 56 428 A1 relates to an automobile securing method, in which a detection means directed to physiological features of an user cooperates with a comparing unit in which the features of authorized users are stored and which outputs for the authorized user a release signal for the operation of the vehicle. In case of an unauthorized user, the comparing unit requests an additional identification feature, stored in a separate memory carried along by the user, wherein the comparison unit outputs a special release signal upon receipt of the additional identification information.

DE 198 42 544 A1 relates to a device for determining the driver authorization, in which, by means of the detection of biometric data, the biometric data of a user are detected and compared with biometric profile data stored by an evaluating means comprising a biometric profile memory, with regard to congruencies, wherein an authorization release signal is also output when the user's biometric data are not stored in the biometric profile memory as long as a code detector detects an operation means signal corresponding to an operation means code. By means of a specific special operation means, operation modes for the memorizing, deleting or amending or storing of biometric profiles and resources can be selected and respective procedures can be performed.

Present systems for the identification of persons mostly comprise portable authentication media like keys, chip cards or transponder which are transferable. Thus, it is not possible to clearly authenticate the user therewith, as each user being in possession of the authentication medium is detected to be authorized. Such authentication media have the disadvantage that they can be stolen or misused if lost. As an alternative or additional safeguard, the identification can be realized by a mental medium such as, e.g., a PIN (personal identification number) or a password. This solution, too, is to be looked upon as not safe, as the relevant information can be spied or tried or guessed.

Particularly, in order to avoid the above problems, biometric or physiologic methods are used, in which persons are identified by means of specific personal features by detecting these features and comparing them with reference features stored in a memory. Here, the reading means or scanner is usually mounted fixedly to the means to be used, e.g., a door. The requirement of an on-line connection to a central database has generally shown to be disadvantageous. Here the maintenance of a database or the storing of user-specific data at a location being not accessible for the users may cause fear in the users, e.g., fear of data misuse. Furthermore, the wiring and the installation of a device for performing the biometric method causes high costs and is, thus, economically suitable only in a few application cases. Particularly in cases, in which, e.g., few users should have access to few means or if a high number of such means are present, such devices have shown to be disadvantageous, especially from an economical or process technical point of view. Furthermore, the authorization signal, e.g., for the opening of a door, is generally only an opening signal for the door opener, i.e., a locked door cannot be opened. Furthermore, according to this method the complicated and expensive reading means or scanner for biometric features is located in the outdoor area, i.e., in an area being accessible for a plurality of persons. Such means are, thus, endangered by damage or manipulation. Furthermore, unauthorized persons have any time for trying to outwit the means (see, e.g., magazine “CT” of May/June 2002).

Additionally, the maintenance of the respective database appears to be time-consuming and costly, as new users have to be entered complicatedly and reference data of persons who are no longer authorized have to be deleted.

Additionally, the use of such methods have shown to be awkward and time-consuming, as for several accesses, e.g., to an automobile, e.g., following on each other rapidly, the identification procedure has to be performed several times. Hereby, an additional validity of portable, not person-specific authentication media destroys the possible advantages of a personal identification. Subsequently, disadvantages develop especially in systems having a plurality of authorized user, a user hierarchy with different authorization levels as well as in systems in which the number and the structure of users are often changed.

It is the object of the present invention to provide a system and a method for securely identifying persons and for permitting or denying logical and/or physical access to target means, which overcomes the above disadvantages. Furthermore, it is an object of the present invention to provide a system and a method which is economical, operates reliable and provides user-friendly operation.

The solution of this (these) object(s) is achieved by a system and a method according to the independent claims. The sub-claims relate to the preferred embodiments.

A system according to the present invention for surely identifying persons and for permitting or denying logical and/or physical access to target means comprises a portable ident(ification) medium. The portable indent medium in its turn comprises at least one biometric sensor, at least one input element, at least one output element, a processor having a memory and a software as well as a transmitting and receiving electronic.

Furthermore, the system comprises a counter station, which is arranged at or near a target means or cooperates with said means. The counter station comprises a reading and evaluating electronic for the validation of the authorization of the ident medium, an actor and a memory.

The system further comprises a temporary alternating magnetic field for the encoded wireless bidirectional data exchange or for performing a so-called challenge response. Furthermore, the system is such formed that it transmits low frequency signals. Ident medium and/or counter station are programmable, especially preferred wireless programmable.

It is preferred that the ident medium and/or the counter station have a handy size, i.e., the size of a match box. Furthermore, ident medium and/or counter station are preferably locally or battery supplied. Furthermore, the ident medium and/or the counter station preferably comprise a battery or accumulator cell and/or are directly chargeable. The at least one biometric sensor is preferably a finger print sensor, an iris- or face-recognition sensor etc. and is preferably connected to life detection, preferably a pulse sensor or a sensor for body temperature.

The biometric sensor of the ident medium is particularly preferable a finger print sensor preferably operating optically, capacitively, thermally or with radio waves. Preferably the sensor is an area or strip sensor. A strip sensor, in which the finger is moved across the sensor, proves to be advantageous against an area sensor on which the finger is laid, for having a smaller area and being thus more economical, space-saving and less sensible with regard to dirt. Furthermore, on a strip sensor no remaining prints of the finger or fingerprint remain which could be misused.

The input element of the ident medium is preferably formed as a key or key board, switch and/or the like. As output element preferably visible output elements, like LEDs, displays and the like, or audible elements like loudspeakers, noise or sound production units are used.

The wireless bidirectional data exchange between ident medium and counter station by means of an alternating magnetic field facilitates, e.g., in comparison with a mere alternating electric field, a secure data exchange or a secure processing of an access control protocol or a challenge response in case of a local separation of the ident medium and the counter station, e.g., by walls, doors, steel, metal, steel armoring, metal armoring and/or the like. The communication via an alternating magnetic fields, is preferably performed in the frequency range of very low frequency waves or long or medium waves. The alternating magnetic field has preferably a reach of up to about 1.5 m and particularly preferred of up to about 2.5 m or more. This results in the particular advantage that an accidental opening or closing is avoided, especially by the fact, that a user can immediately detect such a proceeding by visible or audible signs, e.g., the switching of a locking means or the opening of a door or the starting of a motor, due to his/her vicinity to the target means and reverse the same.

Furthermore, signals between the ident medium and the counter station are preferably transmitted in the low frequency range. Preferably, the communication or the data exchange between the ident medium and the counter station is performed via an electromagnetic field, wherein only the magnetic field component of the electromagnetic field is used but not the electric field component.

While the ident medium is portable, in order to be carried along by a user, the counter station is located at or near the target means or is cooperating with said target means. Here, target means are preferably doors, door cylinders of any kind, particularly doors of buildings, automobile doors, safe or vault doors, doors of switch boards, furniture doors as well as further locking elements and/or latching means, which are suitable to provide a physical access to a target means, like, e.g., a room, an automobile, a safe or a cash dispenser. Furthermore, the term target means are understood to be systems like logical denying mechanisms, computer systems and/or circuitry- or software-based access control systems such as, e.g., driver authorizations or starting authorization in the automobile field, log-ons to computers or computer systems as well as the releasing of firearm securing systems. Thus, the target means is characterized in that a logical and/or physical access of the same is possible, wherein this access is permitted or not permitted or possible or not possible.

Thus, the system according to the present invention permits, for example, the opening and closing as well as the locking and interlocking of doors or locking means of all kind or, for example, the securing and releasing of firearms. The permitting or denying of logical and/or physical access to the target means is performed by an actor. The actor is preferably formed as magnet or solenoid, motor, circuitry, processor, software program and/or the like. Preferably, the actor is connected to a locking element and/or clutch element and locks or unlocks said locking element or disengages or engages said clutch element. Here, the permitting or denying of logical and/or physical access to the target means is preferably performed via the locking and/or clutch element.

The ident medium is preferably formed handily, so that it can be comfortably carried along by the user. Furthermore, the ident medium is preferably formed as an accumulator cell of a mobile telephone or is located at or near such a cell. In the preferred embodiment of the ident medium as an accumulator of a mobile telephone or the like, said accumulator is preferably suitable for being attached to a mobile (as, for example, with Nokia mobiles 6210) or for being inserted into the accumulator case of a mobile, having an additional cover (as with mobiles of the company Siemens).

For the secure personified identifying of a user, the processor or the memory of a portable ident medium preferably comprises a decentralized data base. Said data base is preferably specific for each ident medium. Furthermore, the data base comprises preferably stored biometric data. Thus, already the portable ident medium facilitates a secure personified identifying of a user. The data base is preferably formed such that it is off-line, i.e., it can be established and/or processed directly or exclusively via the ident medium. Furthermore or additionally the ident medium comprises an interface for connecting it with, for example, a computer, which is suitable for processing the data base.

Preferably, a status, e.g., a hierarchy is assigned to the data or user-specific information stored in the data base. Thus, it is possible to distinguish, e.g., between normal users and super users having different authorizations. The data and signals transmitted by the ident medium preferably comprise, inter alia, information on the status of a user (normal user/super user). Preferably, the signal comprise further information on the authorization (authorized/restrictedly authorized/non-authorized) of each user. Preferably the authorized and non-authorized actions corresponding to the status or authorization are stored in the counter station or the data base of the counter station. After evaluating the authorization of the ident medium, the counter station or the evaluating electronic of the counter station initiates a corresponding action as response to the received information. Here, the response is, for example, dependent on the user's status.

As already described, ident medium and counter station are preferably programmable without any wiring. Particularly preferred, ident medium and/or counterstaion are exclusively programmable by at least one authorized user without the aid of further means.

Further features of the system according to the present invention or the ident medium and/or the counter station result from the following discussion of a method according to the present invention, wherein in the following discussion of the method according to the present invention, it is essentially not further referred to system or apparatus features, unless additionally.

The method according to the present invention for the secure personified identification, permitting or denying a logical and/or physical access to a target means which is preferably performed by means of an apparatus described above, comprises the following steps.

First, the identification of a user is performed by means of a portable ident medium wherein biometric data of at least one user are detected by at least one biometric sensor and wherein data and/or orders are entered via at least one input element and operation conditions and/or information are output or displayed by at least one output element.

By means of a processor having a memory and a software comprising a decentralized data base being specific for the ident medium and having stored biometric data, a comparison is performed between the detected biometric of the at least one user and the stored biometric data.

Subsequently, the transmitting of a signal or of data is performed in a low frequency range via an alternating magnetic field in a bidirectional data exchange or via a challenge response by means of a transmitting and receiving electronic wherein the communication is performed with a counter station located at or near the target means or being in cooperation with said target means. The transmitting of such data, signals and/or information is exclusively performed upon a successful identification of the authorized user. Preferably, the above step is performed automatically and/or by means of a respective impulse subsequent to the successful identification of an authorized user. Such an impulse can, for example, be performed by a user via the input element or also by a respective signal of the counter station.

Upon receipt of a signal of the ident medium by the counter station, the evaluation of the authorization of the ident medium or the signal sent, is performed by means of a reading and evaluating electronic.

On the above evaluating of the authorization, the permitting or denying or the allowing or non-allowing of a logical and/or physical access to a target means follows by means of an actor corresponding to the signal received. The concrete action preferably follows a respective input by the user or is predetermined.

Further, the recording of each event is performed with at least, date, time and identification of the ident medium in the ident medium and/or the counter station.

Ident medium and/or counter station are preferably programmable, particularly preferred programmable without any wiring or programmable by a software. Such a programming can be performed at any time, wherein preferably first a successful identification of the user has to be performed by the ident medium.

Furthermore, the data base of the ident medium is made alterable, so that in further method steps additional biometric data can be memorized and/or processed. Preferably, a succesfull identification of a respectively authorized user has to have taken place before the data base can be processed or changed. Thereby, a data base once established, which was memorized or generated in a first step, can be newly memorized, changed or deleted by an authorized user who successfully performed the identification procedure. For this, the respective user data which can be displayed by the output element or identified or assigned can be deleted or data of a new user can be memorized, wherein here the entering of biometric data, e.g., of the fingerprint, is performed by the biometric or fingerprint sensor of the ident medium. Preferably, such a processing of the data base is exclusively performed by means of the ident medium, i.e., without the use of a PC etc. Furthermore, an alignment with a central data base is preferably unnecessary. Preferably, the data base can additionally be processed or changed via an interface by a PC.

Preferably, the signal or code sent by the ident medium depends not only on a successful positive identification but also on an assigned authorization level. Here, besides the differentiation authorized/non-authorized, there is a differentiation according to the user hierarchy, e.g., “normal user”, “super user” etc. Preferably, ident medium and/or counter station permit only defined actions according to the hierarchy level of the identified user. For example, the ident medium first transmits signals or information corresponding to the hierarchy level of the identified user to the counter station, wherein depending on the signals or data received, said counter station permits or conducts certain actions. Thus, preferably the ident medium and/or the counter station can be released by a user of a certain hierarchy level for a predetermined number of, e.g., opening and/or closing actions and/or temporarily, e.g., for the period of one hour. Further, the counter station can permit, e.g., as driver authorization of a vehicle, only a limited speed etc. for a user of a certain hierarchy level. In the field of access authorization to a building or to various single rooms, it is possible to provide access only for individual areas or rooms.

Furthermore, it is possible to adjust the ident medium such that, after and/or with successful identification of a respectively authorized user, a permanent signal is transmitted, so that, e.g., a closed door opens automatically as soon as the ident medium is in the communication radius of the respective counter station. Such a function can preferably be activated automatically or by a respective input of an authorized user. Preferably, such a function can be activated for a limited period of time.

Preferably, the requirement of an biometric recognition can be switched off temporarily or permanently by an respectively authorized user before the ident medium transmits data and information. After the authorized user has once been biometrically identified, the ident medium sends a signal permanently and/or upon a respective impulse by the user and/or the counter station. Additionally and/or instead of the biometric identification of the authorized user, it is preferably necessary for a successful identification to enter a correct PIN (personal identification number) or a password. The establishing, deleting or changing of passwords, PINs or the like is performed corresponding to the changing or working on the data base stored in the ident medium, already described above.

As already described above, ident medium and/or counter station are preferably locally or battery supplied. For an energy-saving operation, e.g., the counter station can be in an energy-saving sleep-mode or stand-by condition for most of the time, wherein the counter station can be addressed and switched over into the operation mode by a special prompt signal of the ident medium. According to the present invention, a prompted counter station remains in the operation mode for a defined period of time and returns into the sleep mode after this period of time.

Preferably a respective recording by the ident medium and/or the counter station takes place with each action of the ident medium and/or the counter station, wherein, further or additionally, the identification attempts and/or the accesses and/or inhibited or denied accesses, locking actions and the like are recorded.

In the following, the present invention is exemplarily described by means of a preferred embodiment or a preferred method with reference to the Figures. Here, reference is only made to the features necessary for an exemplary description. Further or additional features or embodiments result from the description above.

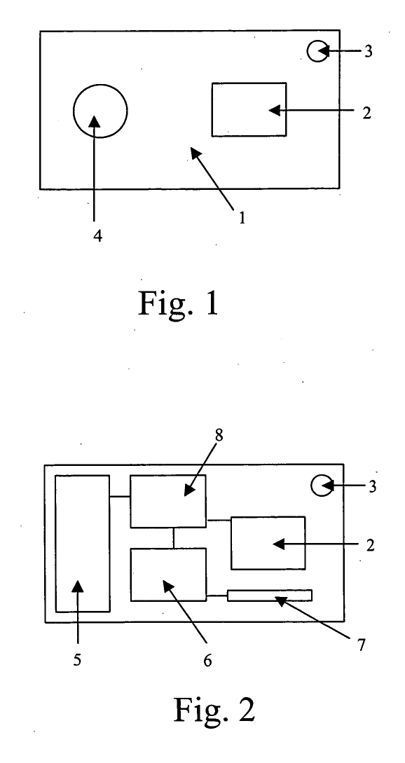

FIG. 1 shows a basic illustration of the top view of a preferred embodiment of the ident medium from the outside.

FIG. 2 shows a basic sketch of an interior view of the ident medium according to FIG. 1.

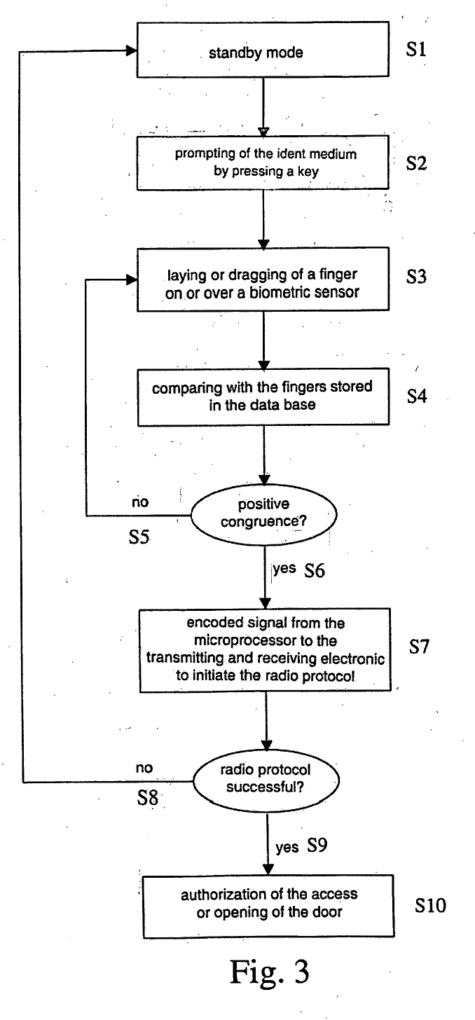

FIG. 3 shows the preferred process of the request for initiating a signal in a preferred embodiment.

FIG. 1. shows a sketch of an outer top view of a preferred embodiment of the ident medium comprising a biometric sensor 2, an output element 3 as well as an input element 4. The ident medium has preferably the size of a matchbox, particularly preferred a length of about 3 cm to 6 cm, a width of about 2 cm to 4 cm as well as a height of about 1 cm to 2.5 cm. The housing of the ident medium is preferably light and robust, e.g., made of aluminum or plastic. The biometric sensor 2 is preferably a finger print sensor on which a finger or a finger tip of the user has to be placed for identification (for example, an area sensor) or over which a finger or a finger tip has to be dragged for identification (for example, a strip sensor). The output element 3 is, for example, a LED while the input element is preferably a key or key element.

FIG. 2 shows a basic sketch of the interior view of the ident medium according to FIG. 1 with the biometric sensor 2 and the output element 3. In the view according to FIG. 2, the input element 4 is not shown for reasons of good overview. The ident medium preferably comprises an energy or current supply 5, a transmitting and receiving electronic 6 having a transmitting and receiving antenna 7 as well as a processor 8 having a memory and a software.

The energy or current supply 5 of the ident medium is preferably a battery or an accumulator cell. The transmitting and receiving electronic 6 together with the transmitting and receiving antenna particularly serves for generating or receiving an alternating magnetic field for the encoded, bidirectional data exchange or for conducting a challenge response and for transmitting signal in the low frequency range. The processor 8 preferably comprises a data base, which can preferably be established or memorized or changed via the ident medium, i.e., via the input element 4, the biometric sensor 2, preferably with the aid of the output element 3. Here, the output element 3 preferably serves for the communication with the user during the memorizing or processing process.

Further, additional or complementary features of the ident medium 1 as well as of the counter station (not shown) result from the above description.

FIG. 3 shows a preferred process of the request for initiating a signal of the ident medium 1. Here, the ident medium is first in a sleep or stand-by mode (S1). By a respective input, e.g., by pressing the key of the input element 4 formed as key or key board (S2), the ident medium is activated or switched into the operation mode. Subsequently, the identifying of the user is performed, preferably by the placing or dragging of a finger on or over a biometric sensor 2 in form of a finger print sensor (S3). The ident medium 1 compares the detected data or the scanned fingerprint with data or identification features stored in the data base in the processor 8 (S4). In case the entered data do not correspond to the stored data (S5), the ident medium awaits a new entering of biometric data (S3). In case, however, the data correspond (S6), the processor 8 transmits an encoded signal to the transmitting and receiving electronic 6 for initiating the radio protocol (S7). Here, the communication with the counter station is performed preferably via an alternating magnetic field for the encoded, bidirectional data exchange or for conducting a challenge response. In case the radio protocol should not be completed successfully, the ident medium changes preferably into the stand-by mode (S8). In case the radio protocol, e.g., the challenge response, is completed successfully (S9), the authorization of the access or entrance etc., e.g., the opening of a door to the target means (not shown) is performed via the counter station (not shown) being in connection with said target means (S10).

Preferably, the device, e.g., the ident medium, changes into the stand-by mode S1 as soon as a certained predetermined period of time has lapsed without an input, e.g., S3, or the receipt of no further signals or inputs, e.g., S8 or S10. At S5, the device also changes correspondingly into the stand-by mode S1 after the n-th, preferably the 4th, unsuccessful input and/or after expiry of a predetermined period of time.

Further, additional or alternative features of the method according to the present invention correspond to the above-described.

The system or the method according to the present invention is advantageous in that it fulfills the requested task(s). Furthermore, the present invention permits a plurality of physical and/or logical accesses for a user, wherein said user only has to be identified by a biometric sensor. Thus, a plurality of complicated identification and access control means can be omitted. Thus, particularly the costs for hardware and administration, e.g., memorizing costs, can be reduced. Besides the reduction of costs, the easement of use or process have an advantageous effect. Furthermore, it is possible to entirely use the advantages of radio based locking and identification mechanisms, e.g., the absence of wiring, easy retrofitting, reading unit in the interior, etc., which particularly results in a high modularity and efficiency. Furthermore, the present invention provides a secure system or method as, for example, a lost ident medium is harmless as it cannot be activated by the unauthorized finder and, thus, remains worthless. Nevertheless, the system or method according to the present invention provides a high user friendliness, as the ident medium, despite its high security, can be transferred by the authorized user, as he can enter new users and/or assign them authorizations within seconds. Here, the user only has to enter, e.g., the biometric data of further persons into the indentmedium. A complicated programming of one or more counter stations is, thus, not necessary. Additionally, such an entering can be performed independent from the location, i.e., a contact to the target means or the counter station is not necessary.

1. A device for securely identifying persons and for permitting or denying a logical and/or physical access to a target means, comprising:
a portable ident medium having
at least one biometric sensor,
at least one input element and at least one output element,
a processor having a memory and a software
as well as a transmitting and receiving electronic and a counter station, which is arranged at the target means or cooperates with said station having,
a reading- and evaluating electronic for checking the authorization of the ident medium,
an actor and
a memory, wherein
an alternating magnetic field is generated for encoded, bidirectional data exchange or for conducting a challenge response, signals in the low frequency range are sent and wherein ident medium and/or counter station are programmable.

2. The device according to claim 1, wherein the biometric sensor is a finger print sensor.

3. The device according to claim 1, wherein the sensor is a sensor operating optically, capacitively, thermally or with radio waves.

4. The device according to claim 1, wherein the sensor is an area or strip sensor.

5. The device according to claim 1, wherein the input element is a key or a key board.

6. The device according to claim 1, wherein the output element is a LED and/or a display.

7. The device according to claim 1, wherein said device is made such that the alternating magnetic field has a reach of up to about 2.5 m.

8. The device according to claim 1, wherein said device is made such that the alternating magnetic field can pervade walls, doors, safes as well as steel, metal, armoring and the like.

9. The device according to claim 1, wherein the actor comprises a solenoid, motor, processor, software program or the like.

10. The device according to claim 1, wherein the actor is in cooperation with a locking element or a clutch element and releases or engages said element.

11. The device according to claim 1, wherein the ident medium is an accumulator cell of a mobile phone.

12. The device according to claim 1, wherein the system comprises a battery or an accumulator cell and/or can be charged directly.

13. The device according to claim 1, wherein ident medium and counter station are wirelessly programmable.

14. The device according to claim 1, wherein ident medium an/or counter station are locally or battery supplied.

15. The device according to claim 1, wherein the processor of the ident medium comprises a decentralized data base being specific for the ident medium, having memorized biometric data.

16. The device according to claim 15, wherein the data base can be changed via the ident medium.

17. A method for securely identifying persons and permitting or denying logical and/or physical access to a target means, comprising the steps of
identifying a user by means of a portable ident medium, wherein biometric data of at least one user are detected by at least one biometric sensor and data and/or orders are entered via at least one input element and operating conditions are output via at least one output element, and wherein a comparison of the detected biometric data with the memorized biometric data is performed by means of a processor having a memory and a software, comprising a decentralized data base being specific for the ident medium and having memorized biometric data;
transmitting of a signal in the low frequency range via an alternating magnetic field in a bidirectional data exchange or via a challenge response by means of a transmitting and receiving electronic after successfully identifying an authorized user to a counter station being located at a target means or being in cooperation with said counter station;
checking the authorization of the ident medium or the signal transmitted by the counter station by means of a reading and evaluating electronic;
permitting or denying of a logical and/or physical access to a target means by means of an actor; and
recording date, time, identification of the ident medium and/or the user for each action.

18. The method according to claim 17, wherein ident medium and/or counter station are programmable.

19. The method according to claim 18, wherein ident medium and/or counter station are wirelessly programmable.

20. The method according to claim 17, wherein the data base can processed or changed via the ident medium by memorizing, deleting and/or processing further biometric data.

21. The method according to claim 20, wherein the processing of the data base is made off-line, i.e., directly via the ident medium.

22. The method according to claim 17, wherein the detection of the biometric data is performed by means of a fingerprint sensor which detects fingerprints according to an optical or capacitive method.

23. The method according to claim 17, wherein the sensor operates optically, capacitively, thermally or with radio waves.

24. The method according to claim 17, wherein the input is performed by means of a key or a key board.

25. The method according to claim 17, wherein the output is effected by means of a LED and/or a display.

26. The method according to claim 17, wherein the actor is a solenoid, motor, processor, software program or the like.

27. The method according to claim 17, wherein the biometric detection can be switched off by the authorized user.

28. The method according to claim 17, wherein it is not only distinguished between authorized and non-authorized users, but furthermore between users having different authorizations or different authorization hierarchies.

29. The method according to claim 28, wherein the reaction of the counter station depends on the authorization or the hierarchy of the user.

30. The method according to claim 17, wherein the identification attempts and/or actions as well as accesses and/or the inhibited or denied accesses are recorded by at least one processor.

31. The method according to claim 17, wherein the ident medium and/or the counter station are locally or battery supplied.

32. The method according to claim 17, wherein the correct entering of a PIN is necessary for identification.

33. The method according to claim 17, wherein the user-specific data memorized in the data base are assigned to a hierarchy, wherein ident medium and/or counter station only permit defined actions according to the hierarchy level of the identified user.
